(19) United States
(12) Patent Application Publication
(10) Pub. No.: US 2012/0148452 A1
(43) Pub. Date: Jun. 14, 2012

(54) NON INVASIVE GAS ANALYSIS

(75) Inventors: Stephen Warwick James Brown, Powys (GB); Peter Douglas, West Glamorgan (GB); William Richard Johns, Reading (GB); Richard Phillips, West Glamorgan (GB); Stephen Robert Ricketts, Leicestershire (GB); Dale Rogers, West Glamorgan (GB)

(73) Assignee: HAEMAFLOW LIMITED, Swansea (GB)

(21) Appl. No.: 13/375,930

(22) PCT Filed: Jun. 3, 2010
(86) PCT No.: PCT/GB10/50936

§ 371 Date: Feb. 27, 2012

(30) Foreign Application Priority Data
Jun. 4, 2009 (GB) 0909587.8

(51) Int. Cl. G01N 21/78; G01N 21/75

(52) U.S. Cl. 422/86; 422/83

(57) ABSTRACT

A sensing device is provided. The device comprises a gas permeable member, a sensing member and optical means.

The gas permeable member is arranged to receive gas from a substance to be tested. The sensing member is located adjacent to the gas permeable member and comprises a sensing substance. A property of the sensing substance is modified when it is brought into contact with the gas received by the gas permeable member.

The optical means comprises a light source which is arranged to irradiate the sensing substance together with a first sensor which is configured to detect a change in the aforementioned property of the sensing substance.

The present invention relates to a device for detecting presence of, and monitoring quantities of, a known species. In particular, to establishing such detection without the need for extracting a sample of the material to be tested.

It is known to sample materials either continuously, e.g. using probe devices, or at intervals by periodically removing a sample of the material and testing it. In this way, an assessment of the fluctuation of a particular property of the material to be tested can be monitored.

A continuous sample stream of a fluid may be taken, which is tested and then either rejected or returned to the main stream. Examples of this technique include magnetic oxygen meters and conductivity cells for carbon dioxide. In both instances, a gas stream is passed through a flow cell in which the analysis takes place.

Alternatively, intermittent samples may be taken that are analysed and then rejected. An example of this technique is a gas or liquid chromatograph, in which a small sample is placed in the chromatograph for separation.

Disadvantages associated with these methods include:
a) provision of a tapping to divert flow to a test cell or a probe, e.g. a hollow needle inserted in a blood stream, through which the sample stream or samples are taken. In fluids such as blood, a device such as a tapping or probe provides a nucleus for clot growth. Similarly, in biological fluids (such as arise in the food and biotechnology industries) a tapping or probe can act as an anchor point upon which growth of undesirable organisms can flourish.
b) the total volume of sample taken may accumulate to the extent that it affects the system being studied.

It is, therefore, desirable to develop a device whereby certain properties of a substance can be continuously detected in a non-invasive manner such that the flow structure of a fluid or the integrity of the solid is not affected.

According to a first aspect, the present invention provides a sensing device comprising:
a gas permeable member arranged to receive gas from a substance to be tested;
a sensing member, located adjacent to the gas permeable member comprising a sensing substance, a property of which substance is modified when brought into contact with the received gas; and
optical means comprising:
a light source arranged to irradiate the sensing substance;
a first sensor configured to detect a change in the property of the sensing substance.

By providing a device having a gas permeable member arranged to receive gas from the substance to be tested, no sample need be taken from the bulk substance. In this way, the substance being analysed does not become depleted. As this gas permeable member can be located flush to a wall of a conduit conveying the substance to be tested, no probe or tapping need be placed within in a fluid stream of the substance to be tested. Consequently, no flow disturbance or nucleus forms at which clots or undesirable species may be able to grow.

Furthermore, no potentially contaminated substance stream is returned to main flow and a device having the same configuration can be used for determining gas partial pressures over gases, liquids, solids or composite materials.

The property may be intensity of light and the first sensor may be configured to detect a change in the intensity of light emitted or absorbed at a characteristic wavelength. The device may comprise transmitting means for transmitting a signal indicative of the property of the sensing substance to analysing means.

The analysing means may be configured to calculate a parameter of the substance to be tested from the detected property of the sensing substance. The parameter may be partial pressure of the gas present in the substance to be tested.

The device may comprise the analysing means, which may comprise receiving means for receiving the signal. Furthermore, the analysing means may comprise storage means for recording and storing the received signal or the calculated parameter.

The gas permeable member may be substantially opaque or, alternatively, it may comprise an opaque membrane. The sensing substance may be a dye sensitive to a specific gas.

The optical means may comprise a first filter, associated with the first sensor. The optical means may comprise a second sensor, and may further comprise a second filter, associated with the second sensor. The light source may be a light emitting diode (LED).

The gas permeable member and the sensing member in combination may be configured to receive a volume of gas less than 3 μl, preferably less than 0.2 μl, more preferably less than 0.01 μl.

The gas to be detected may be oxygen, the light source may be an ultraviolet LED and the sensing substance may be platinum (II) octaethylporphyrin (PtOEP).

The gas to be detected may be carbon dioxide, the light source may be a blue LED and the sensing substance may be 8-hydoxypyrene-1,3,6 trisulfonic acid (HPTS).

According to a second aspect, the present invention provides a blood/air mass exchange apparatus in combination with a sensing device of the aforementioned type.

By installing at least one device in a blood/air mass exchange apparatus, measurement of oxygen and carbon dioxide flow in and out of the blood/air mass exchanger in both the gas and liquid phases can be undertaken. In this way, a complete material balance on the gases can be achieved and the performance optimised.

The, or each, sensing device may be associated with a respective one of the group of a blood inlet of the apparatus, a blood outlet of the apparatus, an air inlet of the apparatus and an air outlet of the apparatus. Means for monitoring a fluid flow in to and out of the apparatus may be provided, which may be configured to monitor a balance of mass flow on a substantially continuous basis.

The aforementioned device may comprise a housing member defining a cavity therewithin, the cavity may be closed by the sensing member and the optical means may be mounted within the cavity. The cavity may comprise a transparent, substantially incompressible medium, e.g. oil or resin. According to a third aspect, the invention thus provides a high pressure environment apparatus, such as deep ocean apparatus, comprising a device of the aforementioned type.

By the term “gas” we mean gases and/or vapours. Consequently, when we refer to a gas permeable membrane, this is also intended to be interpreted to cover a vapour permeable membrane.

The present invention will be described, by way of example only, with reference to the accompanying drawings, in which:

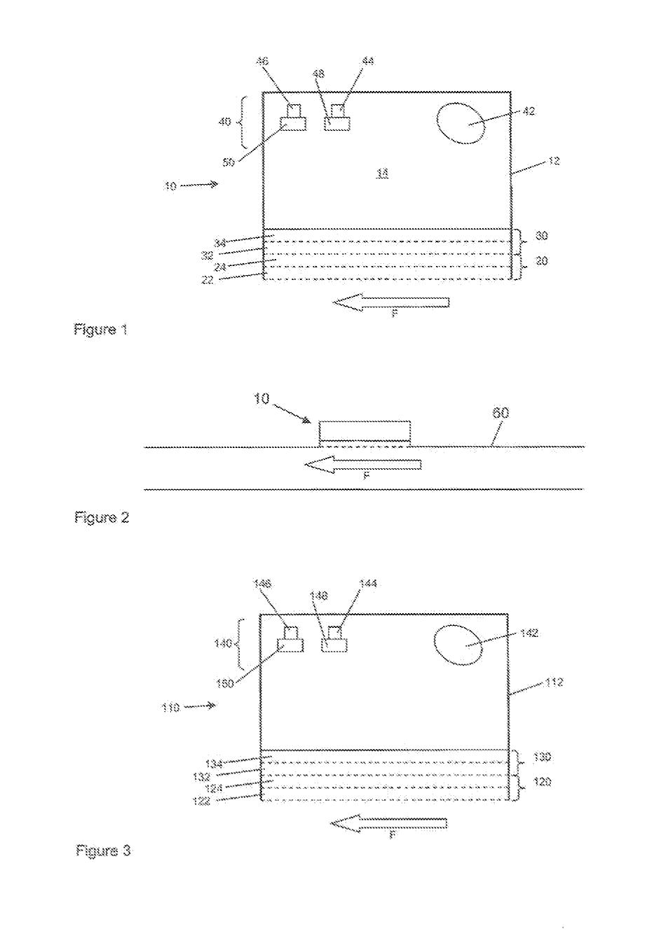

FIG. 1 represents a sensing device;

FIG. 2 represents the device of FIG. 1 in operation;

FIG. 3 illustrates an oxygen sensor;

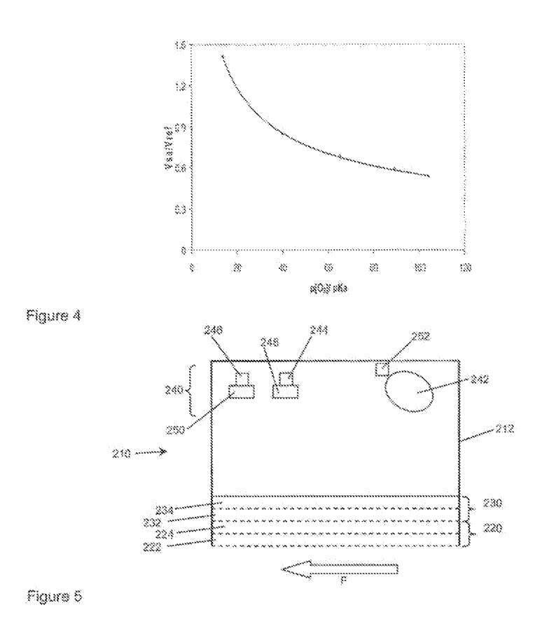

FIG. 4 illustrates how emission from PtOEP varies with oxygen present;

FIG. 5 illustrates a carbon dioxide sensor; and

FIG. 6 illustrates how transmission from HPTS varies with carbon dioxide present.

The device 10 of FIG. 1 represents apparatus for detecting a parameter indicative of a quantity of a known species, present in a fluid flow F with which the device 10 is brought into contact. The device 10 comprises a housing 12, closed by a diffusion member 20 to define a cavity 14 within. In operation, the diffusion member 20 is presented to the substance to be tested, here F.

Adjacent to the diffusion member 20 is a sensing member 30, located in close contact with the diffusion member 20. Optical means 40 are spaced from the sensing member 30. The sensing member 30 and the optical means 40 of the device 10 are enclosed and supported by the housing member 12.

The diffusion member 20 comprises a gas-permeable membrane 22 together with an opaque layer 24. If the gas-permeable layer 22 is, itself, opaque then the secondary opaque layer 24 may be omitted. Alternatively, if the gas-permeable membrane 22 transmits only wavelengths that do not interfere with the active wavelengths to be detected, the secondary opaque layer 24 may be omitted. Layers 22 and 24 may be up to several mm thick but are, preferably, of minimal thickness, say in the range of 20 to 150 microns, more preferably in the range of 20 to 30 microns. The gas-permeable membrane 22 may be provided by a sheet of polymer such as polyphenylene oxide; polyether sulphone; cellulose or other gas permeable membrane. Alternatively, an inert microporous polymer may be used (e.g. polythene, polypropylene or polytetrafluoroethylene). The secondary opaque layer 24 preferably comprises an opaque, highly reflective, say matt white, material e.g. barium sulphate.

The sensing member 30 comprises a layer 32 of gas sensitive dye that reacts to the presence of a specific gas. The sensitivity of the dye is such that the intensity of the colour changes (i.e. emission or absorption at a specific wavelength) in the presence of a specific gas and the extent of the change is a measure of a parameter indicative of a quantity of a known species, e.g. partial pressure or molecular concentration or activity, of the gas that is brought into contact with the dye. The detected colour change may be demonstrated in practice by an emission of light at a characteristic wavelength or, alternatively, it may be demonstrated by absorption of light at a characteristic wavelength. The emission or absorption of light varies in response to a change in the quantity of the species present in the gas. The sensing member 30 also comprises a backing layer 34 to support the gas sensitive layer 32. The backing layer 34 is transparent to a light source but is also gas impermeable such that no gas from the substance F can pass therethrough into the cavity 14. The backing layer 34 may comprise a material of the group of glass, a transparent plastics material and a transparent resin material. The thickness of the backing layer may be up to 50 mm but is preferably in the range of 0.5 to 3.0 mm.

Optical means 40 comprises a light source 42 positioned such that light emitted thereby irradiates the dye of layer 32. The light source 42 is selected to emit light having a particular range of wavelengths. The light source 42 may comprise a filter to further restrict the wavelengths emitted thereby. The light source is positioned in relation to the dye layer 32 such that an angle of incidence, together with an intensity of the light received by the layer 32 is controlled.

Optical means 40 also comprises first and second sensing means 44, 46 for detecting light within the cavity 14 defined by housing member 12. Each respective sensing means 44, 46 is preferably positioned so as to optimally receive light from the dye layer 32. In this embodiment, the first sensing means 44 is provided with one or more filters 48 that are configured to restrict the wavelengths received by the sensor 44. The choice and necessity of filter 48 is determined in relation to the species to be detected and the dyes used to effect that detection. Each light filter is selected on the basis of specific wavelengths to effectively enhance sensitivity of the associated sensor. Furthermore, a light filter serves to remove undesirable wavelengths that would, otherwise, interfere with the signal received by the sensor.

The second sensor 46 is optional and may, once again, be provided with one or more light filters 50. Light filters 50 differ from light filters 48 in that they permit light of a different wavelength to pass therethrough to be received by respective sensing means 46, 44. By providing two such arrangements, light reflected, transmitted or emitted from the dye layer 32 is monitored to enable long-term deterioration in dye performance to be quantified and accommodated. The outputs from the two sensors may be used in combination to give a composition reading and/or to give a stable long-term response. If the dye used is known to be particularly stable over time, the second sensing arrangement 46, 50 can be omitted.

The housing member 12 is completely opaque, preferably having a matte black inner surface. The housing member 12, combined with the opaque layer 24, or 22 when so configured, serves to exclude any light from external sources. If, over time, the opaque layer 24 (or 22) degrades, reducing the opacity thereof, light filters can be used to compensate for and reduce, if not eliminate, any additional light transmitted to the, or each, sensor.

Each sensor is powered by the same power source to avoid fluctuations in reading due to any change in power output. This common power source may be a mains powered power source or, especially for a portable unit, the power source may be provided by stored power means such as a battery.

Two particular examples of the device 10 are given below, in a first example the gas to be detected is oxygen and in the second example, the gas to be detected is carbon dioxide. Many other gases can be detected, it is simply necessary to identify a suitable gas sensitive dye for use in layer 32 of sensing member 30 (e.g. alcohol vapour requiring an alcohol specific dye at a suitable concentration).

In each of the following two embodiments the substance representing fluid flow F, i.e. that to be tested, is blood. The apparatus may be installed in operation as depicted in FIG. 2. As shown, the device is installed in direct contact with a conduit 60 for conveying blood such as may be found in blood/air mass exchange apparatus.

In such apparatus, oxygen transfers from the air to the blood and carbon dioxide transfers from the blood to the air. By installing the device 10 into such apparatus the transfer of oxygen and carbon dioxide can be measured and monitored. For example, each of an oxygen sensing device and a carbon dioxide sensing device can be installed in contact with inlet air, outlet air, inlet blood and outlet blood within the blood/air mass exchange apparatus. In so doing, it is possible to ensure that fluid flows (both blood and air) are always travelling in the correct direction (from a higher pressure region to a lower pressure region) and the pressure differences, driving these flows can also be determined. Furthermore, the total flow of both oxygen and carbon dioxide into and out of the apparatus can be calculated. Any discrepancy between the in flow and the out flow for each species may be indicative of an error in the apparatus that should be investigated. Whereas a lack of discrepancy in these flows suggests that full material balance has been achieved.

This configuration of apparatus enables the partial pressure and changes in concentration to be tracked at different points through the exchanger apparatus. Monitoring of these parameters permits the performance of the mass exchanger to be monitored, analysed and optimised. In this way, full material balance across a mass exchanger can be computed on a continuous basis.

The present invention advantageously allows that at a given temperature and a given geometry and light source intensity, the signal is related to the partial pressure of the gas. Thus, a theoretically sound correlation enables partial pressure to be computed directly from the electrical signal. Furthermore, carbon dioxide partial pressure can be calculated at any fluid temperature (providing that the temperature of the dye layer is the same as that of the fluid). Thus the device can be calibrated to read CO₂ partial pressure directly.

In a first embodiment, the gas to be monitored by a device 110 is oxygen and specific details of example materials and a particular configuration of the device 110 are herein described below with reference to FIG. 3.

A gas sensitive dye layer 132 of a sensing member 130 is provided by platinum (II) octaethylporphyrin (PtOEP) in an ethyl cellulose matrix.

In one embodiment, the oxygen sensing member 30 is prepared as follows. PtOEP is dissolved in tetrahydrofuran (1 mg to 1 ml). 0.4 m1 of this is added to 1 g of ethyl cellulose 10% in toluene: ethanol 80:20 (v/v). For photostability, 0.1 g diazobicyclo[2.2.2]octane is also dissolved in the polymer solution. The resultant solution is spin coated on a glass slide at 1500 rpm. The spin-coating speed and dye concentration may be adjusted to optimise sensitivity over selected instrument ranges of partial pressure depending on application e.g. the partial pressure ranges could be 0.01 to 0.05 kPa, 4 to 10 kPa or 3 to 20 kPa.

In the absence of oxygen, the PtOEP as defined above emits an intense ‘cherry red’ colour when irradiated with UV light. In the presence of oxygen the excited state is quenched and the emission from the PtOEP is reduced. Consequently, the emission intensity can be related to a parameter indicating the level of oxygen present, in this example, partial pressure.

Optical means 140 for the oxygen monitoring device 110 uses a UV LED light source 142 to irradiate the gas sensitive layer 132. First and second sensors 144, 146 are each provided by photosensors. The first sensor 144 is used in combination with a red band pass filter 148 to detect any change in emission from the gas sensitive dye. The level or change in emission intensity is indicative of the oxygen present, namely the oxygen passing through a diffusion member 120 and being brought into contact with the sensing member 130. The second sensor 146 is used in combination with a blue band pass filter 150. This second sensor 146 is a reference sensor, the presence of which enables ratiometric measurements to be made.

FIG. 4 shows a graph of a ratio of signal to reference voltages, thus indicating how the emission from the PtOEP reduces with an increasing presence of oxygen. In particular, the graph of FIG. 4 illustrates how the sensitivity to the level of emission is greatest (i.e. the gradient of the curve is steepest) at low levels of oxygen. The non-linearity of this curve indicates a greater sensitivity at lower partial pressures. Consequently, a device having a natural tendency to increase in accuracy/sensitivity at reduced quantities is provided.

In the second embodiment, (illustrated in FIG. 5), a device 210 for detecting carbon dioxide (CO₂) is described. A carbon dioxide gas sensitive layer 232 comprises 8-hydoxypyrene-1,3,6 trisulfonic acid (HPTS) in a sol-gel matrix with a cetylammonium hydroxide buffer.

In this embodiment, the CO₂ sensor is made as follows. A sol-gel is made by stirring 4 ml of methyltriethyloxysilane (MTEOS) with 1.5 ml of 0.1 M HCl for 2 hours. 80 mg of HPTS is dissolved in 6 ml of the cetylammonium hydroxide solution. 5.2 ml of this is added to the sol-gel after two hours. First an ethyl cellulose layer is spin coated on a glass slide from a solution of 10% ethyl cellulose in toluene: ethanol 80:20 (v/v). The sol-gel solution is then spin-coated onto the slide in two layers, in this example, two layers are provided to ensure a detectable level of emission, however a single layer may suffice. This is then dried for 45 minutes in air, and finally a 2% solution of polystyrene in toluene is spin coated over the slide. Spin coating is approximately 1000 rpm for all layers. This sandwiching of the sensing layers protects them, and also helps the sensor layer adhere to the glass slide. The spin-coating speed and dye concentration may be adjusted to optimise sensitivity over selected instrument ranges of partial pressure depending on application e.g. the partial pressure ranges could be 0.01 to 0.05 kPa, 4 to 10 kPa or 3 to 20 kPa.

Advantageously the CO₂ sol-gel mixture allows improved control over the concentration and distribution of the dye and provides reliable quantitative analysis.

The detection mechanism used in respect of CO₂ is as follows, CO₂ diffuses into the sol-gel matrix and reacts with water to form methanoic acid which, in turn, leads to a change in proton concentration and protonation of the dye. The protonation of HPTS results in a change in absorption (and hence in transmission) together with a reduction in emission. Consequently, changes in either transmission or emission could be used to measure the partial pressure of CO₂. The device 210 can be configured to monitor fluctuations in both transmission and emission in light sensitive dye layer 232. However, if only a single parameter is to be selected, transmission results in the largest signal change and is, therefore, of increased accuracy and sensitivity. Consequently, in this example, the device 210 monitors the partial pressure by recording transmission.

The use of a sol-gel enables accurate adjustment of the thickness and concentration of the dye layer 232. Thus the device can readily provide optimal sensitivity.

Optical means 240 of the device 210 uses a blue LED as a light source 242. The LED may be filtered to substantially eliminate non-relevant wavelengths. A first sensor 244 comprises a photosensor used in combination with a yellow band pass filter 248 to serve as an emission detection means. A second, sensor 246 is used in combination with a blue band pass filter 250 to substantially eliminate unwanted wavelengths and reduce the intensity of the incident light.

The device 210 further comprises a third photosensor 252, irradiated by the light source 242 to monitor any change in output from the light source. A difference in the monitored values between the sensing devices 244, 246 and 252, results in relative values which incorporate/eliminate bias due to intensity of the light source. A filter may be used in combination with the sensor 252.

FIG. 6 shows a graph of a ratio of signal to reference voltages, thus indicating how the transmission of the HPTS changes in the presence of CO₂. Once again, at particularly low levels of gas, the sensitivity indicated by the gradient of the curve is enhanced.

In the aforementioned embodiments, the sensitivity of the device can be tailored, for example, through changes in sensing the level of protonation of the dye, by adjusting concentration of the sensitive component (e.g. HPTS), thickness of the layer, number of layers and alignment of optical means 40.

It is also advantageous that when the sensor is in direct contact with blood, the membrane 22 may be coated with a biocompatible material which reduces the risk of blood clots forming on the membrane. Thus analysis of a continuous flow of blood is provided without the need to take blood samples or risk promoting blood clots.

The aforementioned devices 110, 210 have been described in relation to measuring gases typically found within a blood stream that it may be desirable to monitor over extended periods from hours to weeks. The technology may be applied to other applications where such a continuous monitoring without direct contact between the material to be analysed and the sensor is desirable.

For example, in the biotechnology industry, products are synthesized using organisms (often genetically engineered organisms) which may be grown in continuous or batch fermenters. The organisms grow in a nutrient “broth”. It is necessary to control and monitor oxygen and carbon dioxide concentrations in such broths to control and measure growth rate and product quality. Such monitoring can also provide early warning of the growth of “foreign” organisms, harmful to the desired organism or product. Placing tappings or probes in such broths can provide nuclei for foreign organisms and are also points that are difficult to clean. Consequently, it would be beneficial to use a non-invasive device as detailed by the present invention to overcome these disadvantages.

Similarly, in the food industry, there are requirements to monitor and control food and drink production processes, particularly those based on or including components made by fermentation processes. For such applications, it is possible to select dyes that respond to additional chemical species, such as alcohol. A device of the present invention could, therefore, be used in monitoring the progress of a fermentation process such as micro-brewing.

In environmental monitoring applications, the device could be employed to monitor oxygen and carbon dioxide in natural waters and in the atmosphere. The device may also be used to measure dissolved oxygen and carbon dioxide in the deep oceans without the necessity of withdrawing samples for surface analysis. The slope of the curve in FIG. 6 becomes very steep at low carbon dioxide concentrations, so that atmospheric partial pressures in the range 0.025 to 0.045 kPa can be accurately measured. This coincides with the range of interest for atmospheric carbon dioxide concentration. Indeed, by taking the ratio of CO₂ to O₂ concentration, variations in atmospheric pressure and humidity can be compensated for and a direct reading of CO₂ concentration in ppm for a dry atmosphere can be obtained. The CO₂ partial pressures in ocean water are similar to, but somewhat lower than, those in the atmosphere because equilibrium has not been fully achieved and CO₂ is still actively dissolving in the oceans.

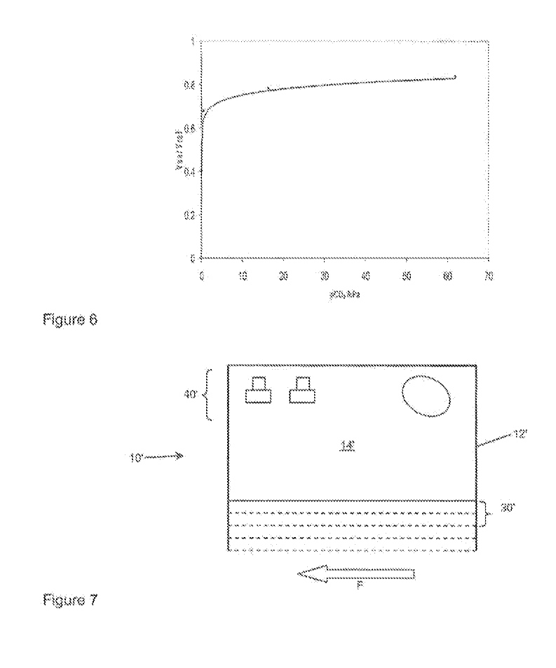

The device 10′ used for high pressure environments, such as a deep ocean application is illustrated in FIG. 7 and is substantially the same as the device 10, described in relation to FIG. 1. However, the cavity 14′, defined by housing 12′ and sensing member 30′ is not filled with air or another gas as in the previous embodiment but, rather, comprises a transparent liquid material e.g. an oil or a transparent solid material e.g. a resin. By using a substantially incompressible medium such as an oil or a resin the integrity of the cavity 14′ is not compromised when the device 10′ experiences high pressures during operation e.g. in a deep ocean application. Further components of the optical means 40′ are fully supported and protected from the high pressures.

When the gas is in direct contact with the gas permeable layer 22 the response time (i.e. the time taken to detect and measure the quantity of the known species) of the device is less than 3 seconds, say approximately 0.5 seconds. Such a fast response time is primarily due to the compact nature of the device and the low volume of gas that must be received by the device to effect a measurement of the known species. The total gas volume received by the device is less than 3 μl, say less than 0.2 μl. With suitable membranes, the volume can be further reduced to approximately 0.01 μl.

The device may, alternatively, be used in contact with a “solid” such as a user's skin. Preferably, the device would be introduced at a location where blood vessels pass close to a surface of the skin. Such use is beneficial where it is desirable to measure blood oxygen and blood carbon dioxide without taking a blood sample and sending it to a laboratory for analysis e.g. for long term continuous monitoring of a patient in an intensive care unit. The skin is a gas permeable membrane, so that the gases in the blood can diffuse through the skin in areas close to blood vessels, particularly capillary vessels. It is possible to get an estimate of the relevant gas partial pressures by sealing an area of skin with the gas-permeable membrane of the device in contact with the skin, whilst carefully excluding atmospheric air from the area. Advantageously, each analyser is preferably an adhesive small patch device which is attached to human or animal skin and is in use wirelessly or otherwise connected to a portable monitor screen. The pattern of gas concentration advantageously indicates stroke type for example and early paramedic treatment can be applied. Gas diffusion through the skin is slow, but readings can nevertheless be obtained. It may be possible to sense other gaseous components, or components having a high vapour pressure, in the blood. For example, it may be possible to monitor blood alcohol levels without taking a blood sample. Response times for the device may be much slower due to the time taken for gases to diffuse through the skin. For example, periods of up to 20 minutes may be required. However, the extended response time is acceptable as the non-invasive nature of the application is very advantageous.

The device can be very compact and light, say in the range of 10 to 100 g and so can readily be worn by a user without becoming burdensome.

It is also envisaged that the membrane utilised for detecting the presence of CO₂ is specifically selected such that only larger acid gas molecules cannot pass there through. Such a membrane can be PPO. Thus the device detects the presence of CO₂ as CO₂ is a very small molecule being approximately 8× more diffusive through PPO than O₂ and 24× more diffusive than NO₂.

Also advantageously the light emitted by the dye is reflected back towards the photosensor rather than being partially dissipated in a test fluid.

1. A sensing device comprising:
a gas permeable member arranged to receive gas from a substance to be tested;
a sensing member, located adjacent to the gas permeable member comprising a sensing substance, a property of which substance is modified when brought into contact with the received gas; and
optical means comprising:
a light source arranged to irradiate the sensing substance;
a first sensor configured to detect a change in the property of the sensing substance.

2. A device according to claim 1, wherein the property is intensity of light and the first sensor is configured to detect a change in the intensity of light emitted or absorbed at a characteristic wavelength.

3. A device according to claim 1, comprising transmitting means for transmitting a signal indicative of the property of the sensing substance to analysing means.

4. A device according to claim 3, wherein the analysing means is configured to calculate a parameter of the substance to be tested from the detected property of the sensing substance.

5. A device according to claim 4, wherein the parameter is partial pressure of the gas present in the substance to be tested.

6. A device according to claim 3, comprising the analysing means and wherein the analysing means comprises receiving means for receiving the signal.

7. A device according to claim 6, wherein the analysing means comprises storage means for recording and storing the received signal or the calculated parameter.

8. A device according to claim 1, wherein the gas permeable member is substantially opaque.

9. A device according to claim 1, wherein the gas permeable member comprises an opaque membrane.

10. A device according to claim 1, wherein the sensing substance is a dye sensitive to a specific gas.

11. A device according to claim 1, wherein the optical means comprises a first filter, associated with the first sensor.

12. A device according to claim 1, wherein the optical means comprises a second sensor.

13. A device according to claim 12, wherein the optical means comprises a second filter, associated with the second sensor.

14. A device according to claim 1, wherein the light source is a light emitting diode (LED).

15. A device according to claim 1, wherein the gas permeable member and the sensing member in combination are configured to receive a volume of gas less than 3 μl.

16. A device according to claim 15, wherein the volume of gas is less than 0.2 μl.

17. A device according to claim 16, wherein the volume of gas is less than 0.01 μl.

18. A device according to claim 1, wherein the gas to be detected is oxygen.

19. A device according to claim 18, wherein the light source is an ultraviolet LED.

20. A device according to claim 18, wherein the sensing substance is platinum (II) octaethylporphyrin.

21. A device according to claim 1, wherein the gas to be detected is carbon dioxide.

22. A device according to claim 21, wherein the light source is a blue LED.

23. A device according to claim 21, wherein the sensing substance is 8-hydoxypyrene-1,3,6 trisulfonic acid.

24. A blood/air mass exchange apparatus in combination with a sensing device according to claim 1.

25. Apparatus according to claim 24, wherein the, or each, sensing device is associated with a respective one of the group of a blood inlet of the apparatus, a blood outlet of the apparatus, an air inlet of the apparatus and an air outlet of the apparatus.

26. Apparatus according to claim 25, comprising means for monitoring a fluid flow in to and out of the apparatus.

27. Apparatus according to claim 26, wherein the means for monitoring is configured to monitor a balance of mass flow on a substantially continuous basis.

28. A device according to claim 1 comprising a housing member defining a cavity therewithin, the cavity being closed by the sensing member, the optical means being mounted within the cavity.

29. A device according to claim 28, wherein the cavity comprises a transparent, substantially incompressible medium.

30. A device according to claim 29, wherein the transparent medium is one of the group of an oil and a resin.

31. A deep ocean apparatus, comprising a device according to claim 29.

32. A device according to claim 1 wherein said device comprising an adhesive patch suitable for adhering to human or animal skin.

33. (canceled)
